(19) United States
(12) Patent Application Publication
(10) Pub. No.: US 2013/0007611 A1
(43) Pub. Date: Jan. 3, 2013

(54) ELECTRONIC READER AND PAGE FLIPPING METHOD THEREOF

(75) Inventors: HAN-CHE WANG, Tu-Cheng (TW); HAI-SHENG LI, Shenzhen City (CN); JIE GUO, Shenzhen City (CN); CHIH-SAN CHIANG, Tu-Cheng (TW); HUI-GANG HE, Shenzhen City (CN); CHIH-HUA HSU, Tu-Cheng (TW); KUAN-HONG HSIEH, Tu-Cheng (TW); FANG-YOU WANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/340,709

(22) Filed: Dec. 30, 2011

(30) Foreign Application Priority Data
Jun. 28, 2011 (CN) 201110176675.8

(51) Int. Cl. G06F 17/00

(52) U.S. Cl. 715/273

(57) ABSTRACT

An electronic reader includes a display unit, and a processing unit. The processing unit includes a file retrieving module, a refreshing mode control module, a block setting module, and a display control module. The file retrieving module retrieves one or more shapes or figures, to be displayed for effect, and the content of a new target page when a content updating signal is received. The refreshing mode control module controls the electronic reader to operate in a refreshing mode. The block setting module determines the blocks to be refreshed and the order in which the blocks are to be refreshed. The display control module controls the display unit to firstly update the content of a block with the one or more shapes or figures, and then update with retrieved new content by refreshing the blocks one after another in a predetermined procedural order. A related method is also provided.

### CROSS-REFERENCE TO RELATED APPLICATION

The present application is related to a copending application Ser. No. ______ (Attorney Docket No. US39877), entitled “ELECTRONIC READER AND PAGE FLIPPING METHOD THEREOF” and filed on ______, which is incorporated herein by reference.

### BACKGROUND

1. Technical Field

The present disclosure relates to an electronic reader and a page flipping method thereof.

2. Description of Related Art

In an electronic reader equipped with an electronic paper display (EPD) for reading, the EPD is a high resolution, low frequency (HRLF) display, and provides a stable reflective display technology that uses ultra-low power but is easily read under any lighting condition including direct sunlight. However, the EPD typically has a low frame rate, and when a page flipping command is acted upon, the whole screen displaying the current page is refreshed at one time. That is, the content updating on the whole screen is carried out in one operation. Thus, image artifacts, generally caused by image ghosting or image lag, may exist when the EPD is refreshed, which affects users' viewing on the EPD.

Therefore, what is needed is an electronic reader and a page flipping method thereof alleviating the limitations described above.

### BRIEF DESCRIPTION OF THE DRAWINGS

The components in the drawings are not necessarily drawn to scale, the emphasis instead being placed upon clearly illustrating the principles of an electronic reader and a page flipping method thereof. Moreover, in the drawings, like reference numerals designate corresponding sections throughout the several views.

FIG. 1 is a block diagram of an electronic reader in accordance with an exemplary embodiment.

FIG. 2 is a flowchart of a page flipping method for electronic devices, such as the one of FIG. 1, in accordance with the exemplary embodiments.

FIGS. 3-5 are schematic diagrams of the electronic reader of FIG. 1, showing the page flipping process, in accordance with an exemplary embodiment.

FIGS. 6-10 are schematic diagrams of the electronic reader of FIG. 1, similar to FIG. 3-5, but showing the page flipping process of another exemplary embodiment.

### DETAILED DESCRIPTION

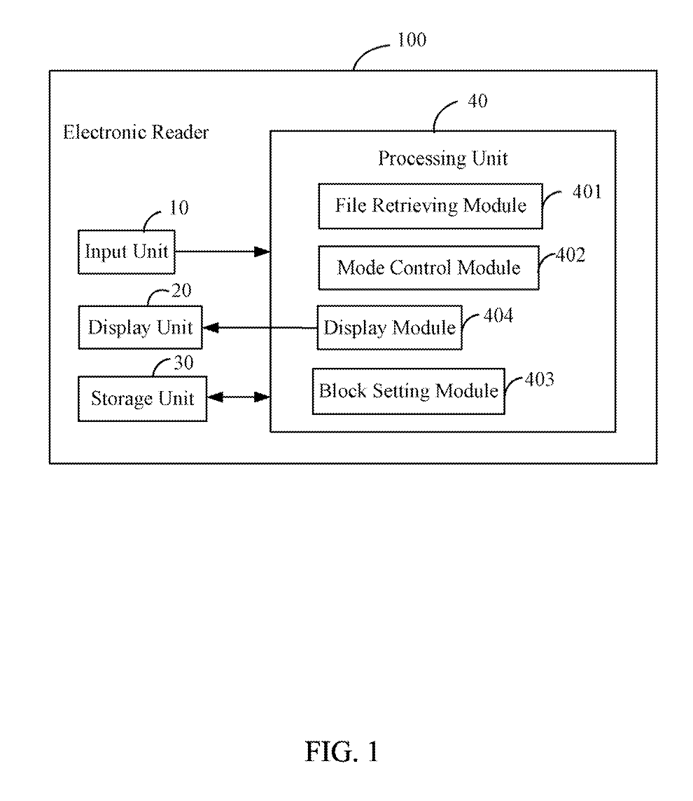

Referring to FIG. 1, an electronic reader 100 is disclosed as an exemplary embodiment. The electronic reader 100 includes an input unit 10, a display unit 20, a storage unit 30, and a processing unit 40.

The input unit 10 is configured to generate a content updating signal in response to a user input, to update the content of the display unit 20, and to transmit signals accordingly to the processing unit 40. The input unit 201 can be a keypad or a touch pad which includes operable function keys such as page up, page down, play, pause, stop, skip, speed, record etc. The function keys of the input unit 201 can be mapped according to actual need.

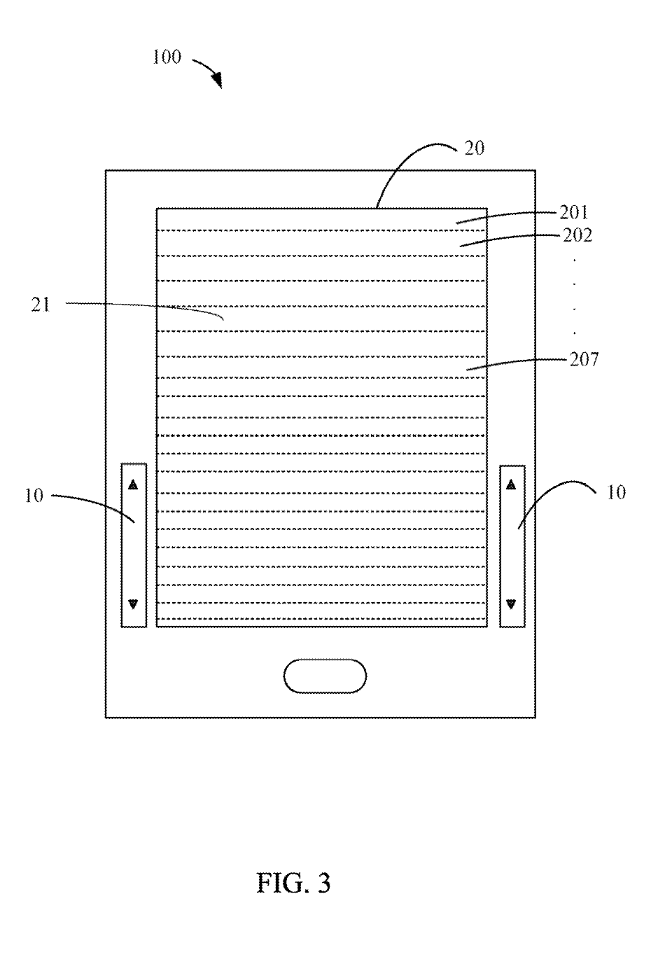

The display unit 20 is an EPD including an electronic paper display screen 21 (See FIG. 3) for displaying content. The storage unit 30 stores a number of electronic files. The processing unit 40 includes a file retrieving module 401, a mode control module 402, a block setting module 403, and a display control module 404.

The file retrieving module 401 retrieves the content of a target page for displaying on the display screen 21, from the storage unit 30, in response to a content updating signal from the input unit 10.

The mode control module 402 is configured to control the electronic reader 100 to operate in a refreshing mode, when a content updating signal for updating the content of the display unit 20 is received. In the embodiment, each refreshing mode defines a particular procedure for the refreshing, and a total number of blocks successively set to be refreshed according to the refreshing mode. The refreshing as viewed by the user includes refreshing the display screen 21 from the top to the bottom or the reverse, and from the left to the right or the reverse, and in a clockwise or in a counter-clockwise direction. The refreshable blocks may be rectangular or another predetermined shape. In the embodiment, when the electronic reader 100 is in the refreshing mode, the refreshable blocks will be refreshed one after another according to the procedure for the refreshing mode. The default refreshing mode is predetermined by the system, and can also be preset by the user.

The block setting module 403 determines the number of refreshable blocks in which new, that is to say retrieved content, is to be displayed. In the embodiment, the block setting module 403 divides the display unit 20 into a number of refreshable blocks as defined in the refreshing mode activated by the mode control module 402. The block setting module 403 also splits the content of the target page into a number of target portions, each target portion being mapped and corresponding to a particular refreshable block. In the embodiment, the refreshable blocks have a uniform size and shape, that is, the display unit 20 is divided into a number of equal parts. Accordingly, the target page as mapped to the display unit 20 is also split into the same divisions.

The display control module 404 updates the blocks one after another with the target portions of the target page appropriately placed in accordance with the refreshing procedure defined by the refreshing mode.

In a second embodiment, the storage unit 30 further stores at least one visually indicative effect figure 300 as part of the content updating effect, such as one of the figures 300 to indicate the page flipping effect, for display on the display unit 20. An exemplary effect figure 300 is a presentation of black and white stripes. Another exemplary effect figure 300 may be a blank shape or figure.

During the content updating process, the file retrieving module 401 invokes one or more effect figures 300 from the storage unit 30 for covering or infilling the block to be refreshed. The display control module 404 maintains the effect figures 300 in the block to be refreshed for a predetermined period of time and then replaces the effect figures 300 with the target portion allocated to that block. Then the content updating process moves on to the next block to be refreshed according to the refreshing procedure. In an alternative embodiment, the content updating process pauses for a short period of time before applying itself to the next block to be refreshed. As the refreshable blocks are refreshed one after another, the old content on the screen of the display unit 20 is reduced portion by portion, the effect figures 300 is/are moved from one refreshable block to another in accordance with the refreshing procedure, and the new content appears portion by portion on the screen until the new screen content has entirely replaced the old.

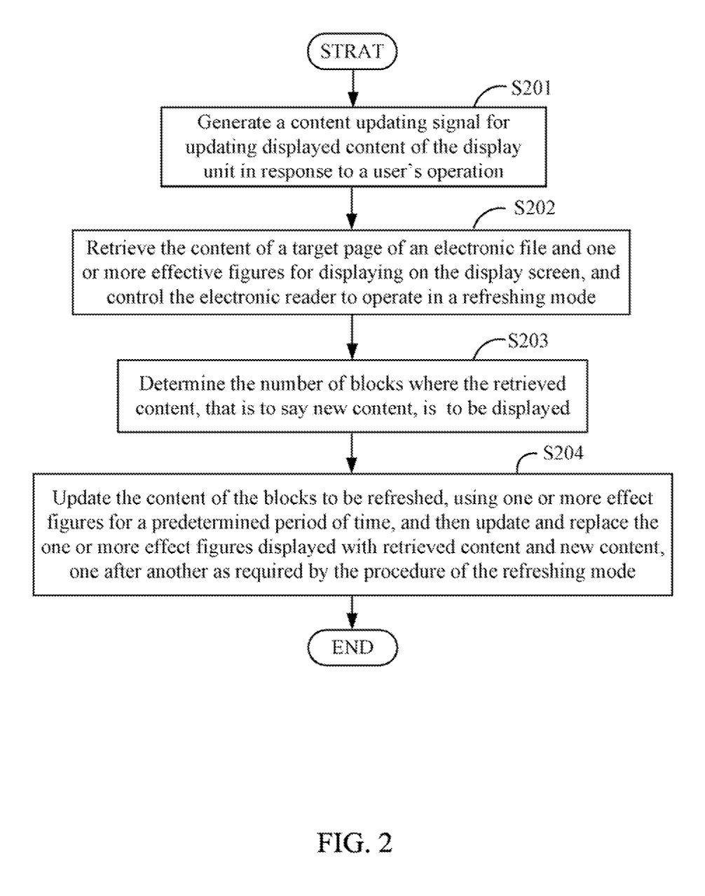

Referring to FIG. 2, a flowchart of a page flipping method of the electronic reader 100 of FIG. 1 is shown. The method includes the following steps, each of which is connected to the various components contained in the electronic reader 100.

In step S201, the input unit 10 generates a content updating signal for updating displayed content of the display unit in response to a user's operation.

In step S202, the file retrieving module 401 retrieves the content of the target page of an electronic file and one or more effect figures 300 for displaying on the display screen 21, and the mode control module 402 controls the electronic reader 100 to operate in a particular refreshing mode. In the embodiment, each refreshing mode defines a particular order and procedure for refreshing, and a total number of blocks is set successively for refreshing in accordance with the particular refreshing mode. A procedure for each refreshing mode may include refreshing from the top to the bottom of the display screen 21, or the reverse, from the left to the right, or the reverse, and in a clockwise or a counter-clockwise direction. The shape of the refreshable blocks may be rectangular or some other predetermined shape.

In step S203, the block setting module 403 determines the number of blocks where retrieved content, that is to say new content, is to be displayed. In the embodiment, the block setting module 403 divides the display unit 20 into a number of blocks to be refreshed as defined by the activated refreshing mode, and splits the content of the target page into a number of target portions, each target portion corresponding to the size and shape of the blocks to be refreshed, and the target portion is mapped to the refreshable block.

In step 204, the display control module 404 controls the display unit 20 to update the content of the blocks to be refreshed, using one or more effect figures 300 for a predetermined period of time, and then to update and replace the one or more effect figures 300 displayed with retrieved and new content, one after another as required by the procedure of the refreshing mode.

Referring to FIGS. 3-5, the page flipping process of the electronic reader 100 in accordance with a first embodiment is shown. In this embodiment, the refreshing mode and the refreshing procedure associated with it is predetermined by the system, the refreshing order for refreshing the screen is from the top to the bottom. The refreshing mode and associated procedure also can be predetermined by the user.

Referring to FIG. 3, the display unit 20 of the electronic reader 100 is displaying a current page. The user presses the upper portion of the input unit 10 to generate a page down flipping signal. The file retrieving module 401 retrieves the content of the target page (which is the page following the current page), and the mode control module 402 activates the refreshing mode. As the applicable refreshing mode dictates, the block setting module 403 divides the display unit 20 into a number of consecutive refreshable blocks as illustrated in FIG. 3, which shows a first refreshable block 201, a second refreshable block 202, and a seventh refreshable block 207, until the display area is filled with such refreshable blocks. The block setting module 403 further splits the content of the target page into a number of target portions such as (by way of example only) a first target portion 201′, a sixth target portion 206′, and a seventh target portion 207′.

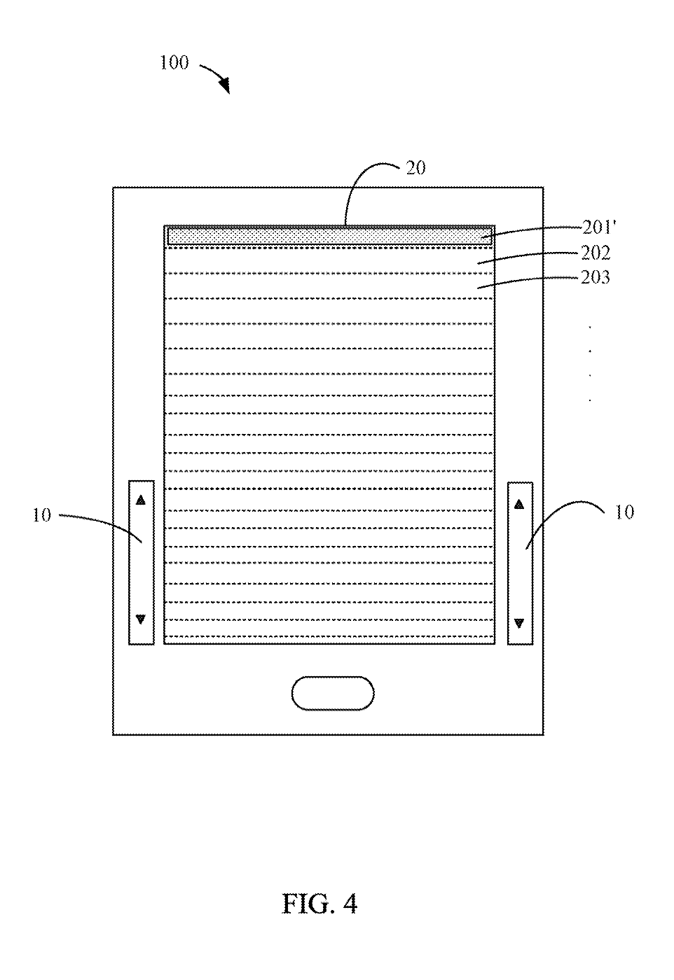

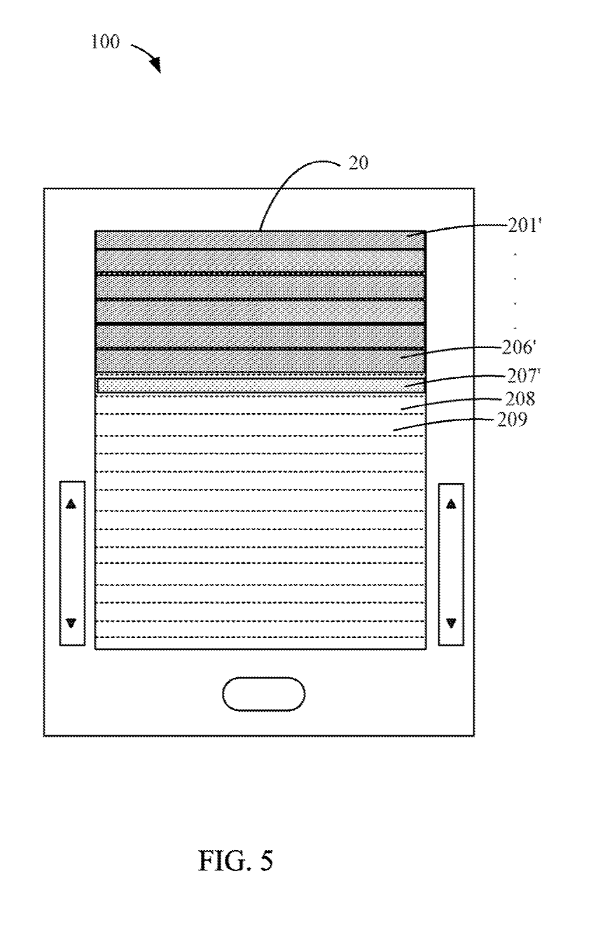

The display control module 404 updates the refreshable blocks one after another, from the top to the bottom, by replacing the current content with the target page. In detail, referring to FIG. 4, the display control module 404 updates the first refreshable block 201 of the display unit 20 with the first target portion 201′, while the other blocks of the display unit 20 continue their current display. The display control module 404 controls the display unit 20 to update the blocks to be refreshed one after another. Referring to FIG. 5, the blocks 201-207 are respectively updated with the target portions 201′-207′, while the remaining blocks continue their current display. When all of the target portions of the target page are displayed on the corresponding blocks of the display unit 20 in place of the previous content, the electronic reader 100 has finished the process for flipping a page.

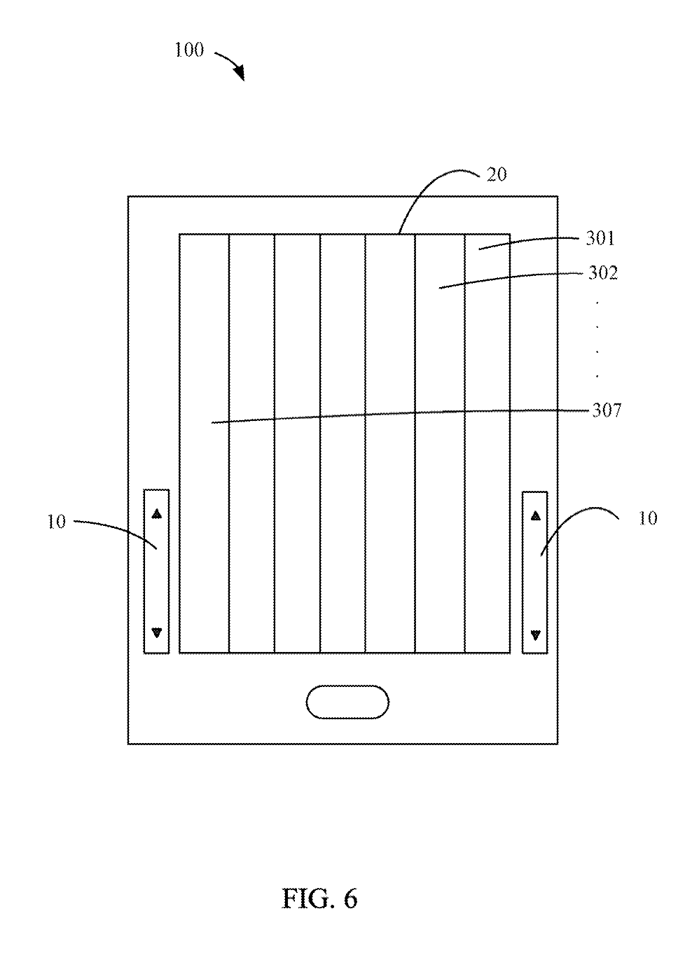

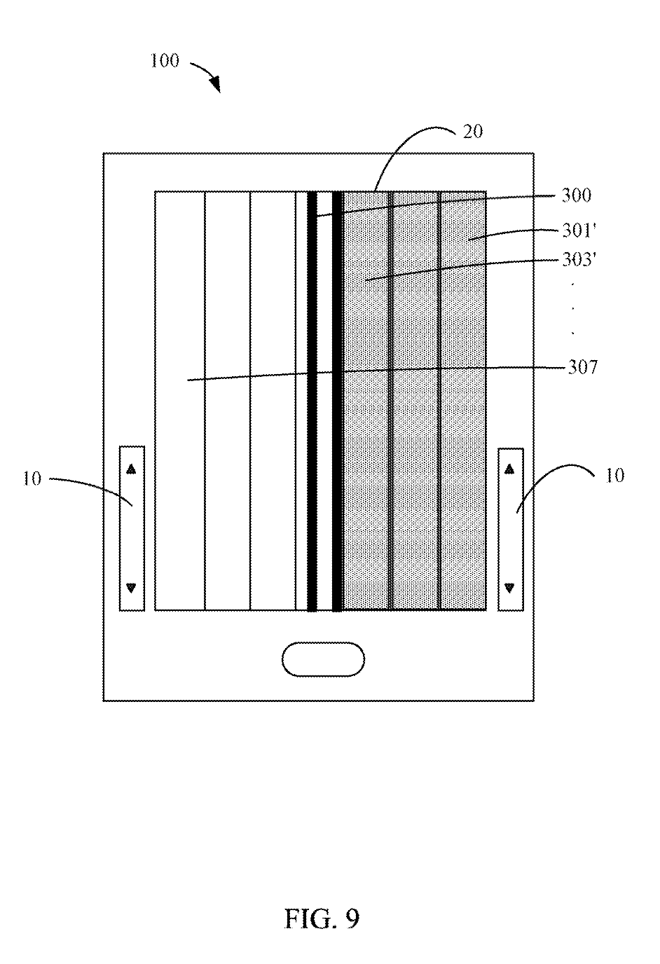

Referring to FIGS. 6-10, the page flipping process of the electronic reader 100 in accordance with a second embodiment is shown. The differences between the second embodiment and the first embodiment are: the default ordered procedure of the applicable refreshing mode in the electronic reader 100 refreshes the screen of the display unit 20 from right to left, and the storage unit 30 further stores an effect figure 300 for display during the page flipping effect. The exemplary effect figure 300 is a presentation or image composed of black and white stripes. The default refreshing mode also can be predetermined by the user.

Referring to FIG. 6, the display unit 20 of the electronic reader 100 displays the content of a current page. Having been input by a user on the upper portion of the input unit 10, the input unit 10 generates a page down flipping signal. The file retrieving module 401 retrieves the content of the target page, which is the next page following the current page, and the mode control module 402 activates the refreshing mode which requires the refreshing of the screen to be from right to left. The block setting module 403 divides the display unit 20 into a number of blocks to be refreshed such as a first refreshable block 301, a second refreshable block 302, and seventh refreshable block 307, all as illustrated in FIG. 6. The block setting module 403 further splits the content of the target page into a number of target portions such as a first target portion 301′, a third target portion 303′, and a seventh target portion 307′.

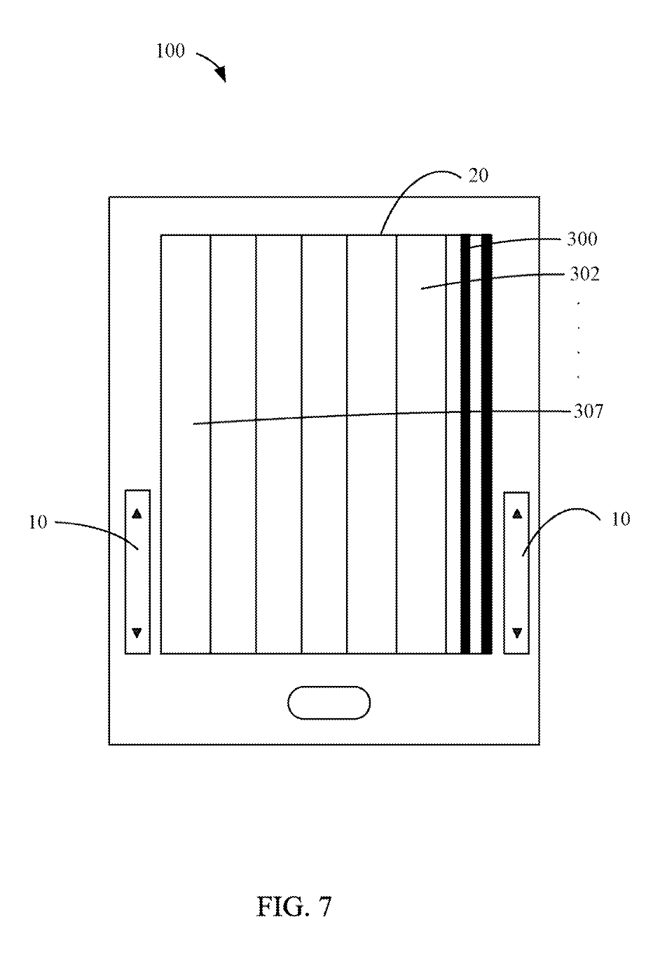

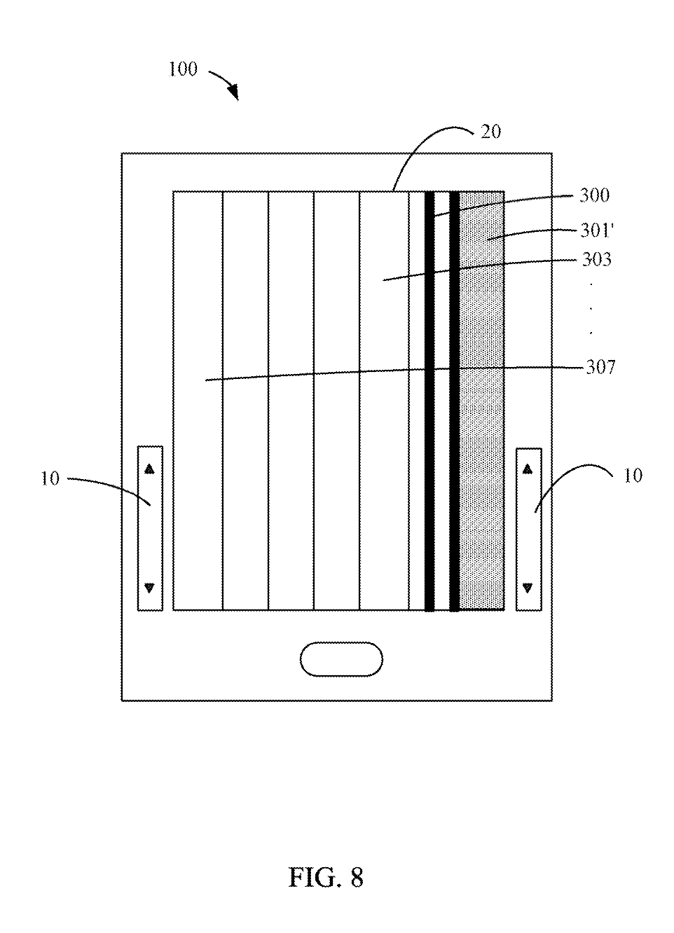

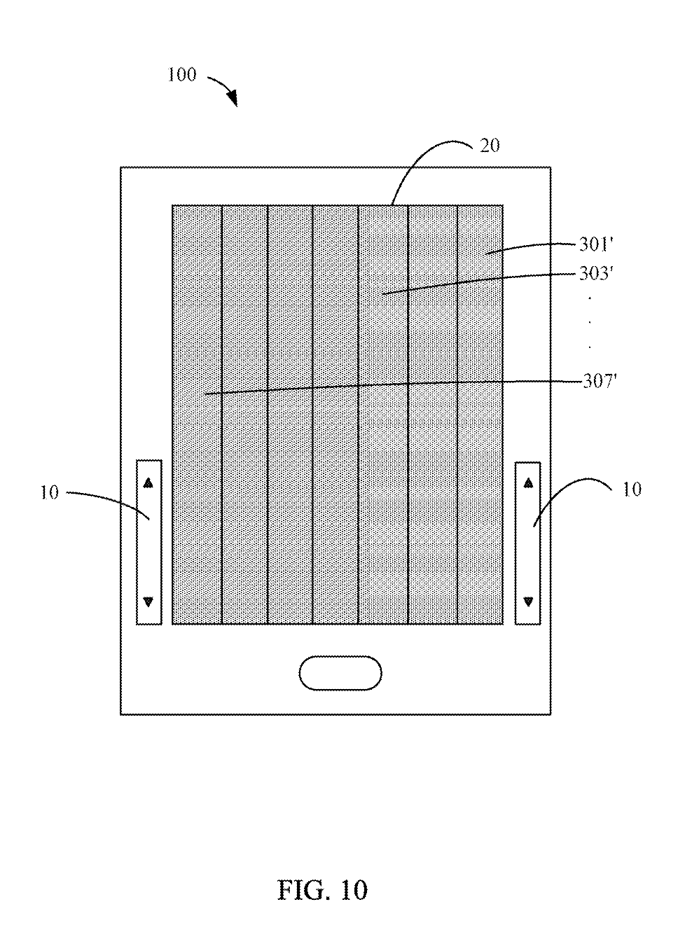

The display control module 404 invokes the effect figure 300 from the storage unit 30 to infill the first block to be refreshed and then to move to and infill the next block to the left, and then to move to and infill the next block to the left, and to continue in that manner until all the blocks have been refreshed with new content. The display control module 404 also displays the effect figure 300 in the refreshable block for a predetermined period of time and then replaces the effect figures 300 with the target portion corresponding to that block. In detail, referring to FIG. 7, the display control module 404 invokes the effect figure 300 from the storage unit 30 to fill the first Page 10 of 17 refreshable block 301 first. The display control module 404 maintains the display of the effect figure 300 in the first refreshable block 301 for a predetermined period of time, while the other refreshable blocks of the display unit 20 maintain their current display. Then the display control module 404 replaces the effect figure 300 with the first target portion 301′ in the first refreshable block 301. In this way, the display control module 404 controls the display unit 20 to update the refreshable blocks one after another, so the effect figure 300 is displayed in the block on the extreme right first, and as short intervals of time go by, the effect figure 300 appears to move across the display screen from right to left, leaving behind target portions of new content. Referring to FIG. 8, the first refreshable block 301 is updated with the first target portion 301′, the second refreshable block 302 is updated with the effect figure 300, and the remaining blocks continue their current display. When every one of the target portions of the target page is displayed in its corresponding block of the display unit 20 (see FIG. 10), the page flipping process of the electronic reader 100 has been completed.

With such a configuration, a vivid page flipping effect is presented to the user of the electronic reader 100, and the appearance of screen artifacts is avoided, which gives more attractive and comfortable viewing to the user.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. An electronic reader comprising:
an input unit configured to generate a content updating signal in response to user's operation;
a storage unit for storing electronic files and one or more effect figures;
a display unit including a display screen configured to display content thereon; and
a processing unit comprising:
a file retrieving module configured to retrieve one or more effect figures and content of an electronic file for displaying on the display screen from the storage unit, in response to the content updating signal;
a mode control module configured to control the electronic reader to operate in a refreshing mode in which the display screen is divided into a plurality of predetermined refreshable blocks;
a block setting module configured to determine one or more refreshable blocks where there is the corresponding retrieved one or more effect figures and content to be displayed; and
a display control module configured to control the display unit to firstly update the content at the determined refreshable blocks with the one or more effect figures, and then control the display unit to update the one or more effect figures with corresponding retrieved content by refreshing the determined refreshable blocks one after another in a predetermined refreshing direction.

2. The electronic reader as described in claim 1, wherein the one or more effect figures are selected from the group consisting of a presentation of black and white stripes, and a blank figure.

3. The electronic reader as described in claim 1, wherein the refreshing direction is from the top of the display screen to the bottom thereof or the reverse.

4. The electronic reader as described in claim 1, wherein the refreshing direction is from the right of the display screen to the left thereof or the reverse.

5. The electronic reader as described in claim 1, wherein the content updating signal is a page flipping signal.

6. The electronic reader as described in claim 1, wherein the refreshing mode is a default mode.

7. The electronic reader as described in claim 1, wherein the display unit is an electronic paper display device.

8. A page flipping method for an electronic reader, the electronic reader comprising a display unit, the method comprising:
generating a content updating signal for updating displayed content of the display unit in response to a user's operation;
retrieving one or more effect figures and content of an electronic file for displaying on the display screen and controlling the electronic reader to operate in a refreshing mode;
determining and choosing one or more refreshable blocks where there is the corresponding retrieved content to be displayed; and
updating the chosen refreshable blocks with the one or more effect figures, and then updating the one or more effect figures with the corresponding retrieved content by refreshing the determined refreshable blocks one after another in a predetermined refreshing direction.

9. The method as described in claim 8, wherein the content at the not-chosen refreshing blocks is not refreshed and is kept unchanged on the display unit.

10. The method as described in claim 8, wherein the step of determining a plurality of refreshable blocks where there is the corresponding retrieved content to be displayed comprises:
dividing the display unit into one or more refreshable blocks; and
splitting the content of the target page into one or more target portions, each target portion corresponding to a refreshable block and being mapped to the refreshable block.

11. The method as described in claim 8, wherein the one or more effect figures are selected from the group consisting of a presentation of black and white stripes, and a blank figure.

12. The method as described in claim 8, wherein the refreshing mode defines a refreshing direction which is from the top of the display unit to the bottom thereof or the reverse.

13. The method as described in claim 8, wherein the refreshing mode defines a refreshing direction which is from the right of the display unit to the left thereof or the reverse.

14. The method described in claim 8, wherein the refreshing mode is a default mode.

15. The method as described in claim 8, wherein the display unit is an electronic paper device.
